(19) United States
(12) Patent Application Publication
(10) Pub. No.: US 2005/0212740 A1
(43) Pub. Date: Sep. 29, 2005

(54) Display device, driving method thereof, and electronic apparatus using the same

(75) Inventor: Keisuke Miyagawa, Zama (JP)

Correspondence Address: COOK, ALEX, McFARRON, MANZO,;CUMMINGS & MEHLER, LTD., SUITE 2850, 200 WEST ADAMS STREET, CHICAGO, IL, 60606, US

(73) Assignee: Semiconductor Energy Laboratory Co., Ltd.

(21) Appl. No.: 11/088,136

(22) Filed: Mar. 23, 2005

(30) Foreign Application Priority Data
Mar. 26, 2004 (JP) 2004-092516

(51) Int. Cl. G09G 3/36

(52) U.S. Cl. 345/89

(57) ABSTRACT

A time division gray scale display device with a pseudo contour effectively suppressed, and a driving method thereof. A display device wherein one frame period of a digital video signal includes a plurality of subframes having different powers, comprising a pixel matrix portion, a signal line driver circuit, a scan line driver circuit, a frame frequency converter circuit for converting the frame frequency of an inputted digital video signal in frame, a time division gray scale signal generation circuit for converting the digital video signal in frame into a gray scale signal in subframe, and a controller for supplying a time division gray scale signal to the pixel matrix portion by controlling the time division gray scale signal generation circuit, the signal line driver circuit, and the scan line driver circuit. The frame frequency converter circuit outputs a digital video signal having a frame frequency of 75 Hz or more.

### BACKGROUND OF THE INVENTION

1. Field of the Invention

The present invention relates to a time division gray scale display device in which generation of a pseudo contour is suppressed, and a driving method thereof. In particular, the invention relates to a time division gray scale display device employing an organic EL, and a driving method thereof. In addition, the invention relates to an electronic apparatus using such a display device.

2. Description of the Related Art

In recent years, an active matrix display device employing a digital video signal has been actively researched and developed. For such an active matrix display device, for example, a liquid crystal or an organic EL is employed. In an active matrix display device, a moving image display is generally performed by displaying 60 pieces of still images (frames) per second continuously (that is, the frame frequency is 60 Hz). As a method for performing a gray scale display by employing a digital video signal, an area division driving method and a time division driving method are known.

In the time division driving method, a gray scale display is performed by controlling the time during which a pixel emits light. Specifically, one frame period is divided into a plurality of display periods (each called a subframe or a subfield) each raised to a different power (that is, duration). In addition, a digital video signal determines whether a pixel emits light or not in each subframes (such a digital video signal is called a time division gray scale signal). The gray scale of a pixel is found by multiplying the length of a subframe during which the pixel emits light in the all subframes within one frame period. For example, in the case where a 6-bit digital video signal is employed, 6 subframes (Tr1 to Tr6) are included in one frame. When the shortest subframe is Tr1, by setting the length ratio of Tr1 to Tr6 to be 2⁰: 2¹: 2²: 2³: 2⁴: 2⁵, a gray scale display of 0 to 63 gray scales can be performed. Generally, in the case where a n-bit digital video signal is employed, a gray scale display of 0 to 2n-1 gray scales can be displayed.

In such a time division gray scale display device, a pseudo contour (or a false contour) may be perceived at a portion where the gray scale changes smoothly, where a boundary is not supposed to be generated, when displaying a moving image. Pseudo contour generation mechanism is described below using FIGS. 10A and 10B.

FIG. 10A shows a pixel portion of a display device in which a pseudo contour is perceived, and FIG. 10B shows a rate of the length of the emission period within one frame period in the pixel portion.

An image is displayed using a 6-bit digital video signal capable of displaying a gray scale of 0 to 63 gray scales in FIGS. 10A and 10B. The right half of the pixel portion shown in FIG. 10A performs a display of 32 (25) gray scales, and the left half thereof performs a display of 31 (25-1) gray scales. In other words, a pixel for displaying 32 gray scales emits light during the longest subframe Tr6 and does not emit light during the other subframes Tr1 to Tr5, whereas a pixel for displaying 31 gray scales does not emit light during the longest subframe Tr6 and emits light during the other subframes Tr1 to Tr5.

As shown in FIG. 10B, in a region for displaying 31 gray scales of the pixel portion, a pixel emits light during 31/63 of one frame period, and a pixel does not emit light during 32/63 thereof. The emission period and the non emission period come up alternately.

On the contrary, in a region for displaying 32 gray scales of the pixel portion, a pixel emits light during 32/63 of one frame period, and a pixel does not emit light during 31/63 thereof. The emission period and the non emission period come up alternately.

In the case where a moving image is displayed, in FIG. 10A, it is assumed that a boundary between the region for displaying 31 gray scales and the region for displaying 32 gray scales is moved in the direction shown by a dotted line. That is, near the boundary, a pixel switches from displaying 31 gray scales to displaying 32 gray scales. Therefore, in the pixel near the boundary, right after an emission period for displaying 31 gray scales, an emission period for displaying 32 gray scales is started. Accordingly, the pixel seems to emit light continuously during one frame period to human eyes. This is perceived as an unnatural bright line on the screen.

On the contrary, in FIG. 10A, it is assumed that a boundary between the region for displaying 32 gray scales and the region for displaying 31 gray scales is moved in the direction shown by a solid line. That is, near the boundary, a pixel switches from displaying 32 gray scales to displaying 31 gray scales. Therefore, in the pixel near the boundary, right after an emission period for displaying 32 gray scales, an emission period for displaying 31 gray scales is started. Accordingly, the pixel seems not to emit light continuously during one frame period to human eyes. This is perceived as an unnatural dark line on the screen.

As described above, the unnatural bright line and dark line appeared on the screen are display disturbances which are called pseudo contours (moving image pseudo contours).

In the case of a still image, display disturbance may also be perceived due to the same reason as that for a moving image pseudo contour in the case of a moving image. Moreover, even in the case where the gray scale is identical, a pseudo contour can be perceived at a boundary between pixel areas where light-emitting timing is different from each other.

In order to prevent such a pseudo contour in a time division gray scale display device, it is proposed that a long subframe (Tr6 for example) is divided into a plurality of display periods (divided display periods) based on a specific rule, and the plurality of divided display periods are arranged separately within one frame (see Patent Document 1).

[Patent Document 1] Japanese Patent Laid-Open No.2002-149113

### SUMMARY OF THE INVENTION

However, even according to the afore-mentioned driving method, a pseudo contour may be perceived. Accordingly, a main feature of the invention is to provide a time division gray scale display device in which generation of a pseudo contour can be effectively suppressed, and a driving method thereof.

In order to solve the foregoing problem, according to the invention, a display device (100) in which one frame period of a digital video signal is divided into a plurality of subframe periods (Tr1 to Tr6) each raised to a different power. The display device (100) comprises a pixel matrix portion (110), a signal line driver circuit (120), a scan line driver circuit (130), a frame frequency converter circuit (170) for converting the frame frequency of an inputted digital video signal in frame, a time division gray scale signal generation circuit (160) for converting a digital video signal in frame from the frame frequency converter circuit into a gray scale signal in subframe, and a controller (150) for supplying a time division gray scale signal to the pixel matrix portion by controlling the time division gray scale signal generation circuit, the signal line driver circuit, and the scan line driver circuit. The frame frequency converter circuit outputs a digital video signal having a frame frequency of 75 Hz or more.

A digital video signal which is outputted by the frame frequency converter circuit preferably has a frame frequency within a range of 90 Hz to 150 Hz, and more preferably within a range of 100 Hz to 120 Hz.

According to the invention, a display device (100a) in which one frame period of a digital video signal is divided into a plurality of subframes (Tr1 to Tr6) each raised to a different power is provided. The display device (100a) comprises the pixel matrix portion (110), the signal line driver circuit (120), the scan line driver circuit (130), the time division gray scale signal generation circuit (160) for converting an inputted digital video signal in frame into a gray scale signal in subframe, and the controller (150) for supplying a time division gray scale signal to the pixel matrix portion by controlling the time division gray scale signal generation circuit, the signal line driver circuit, and the scan line driver circuit. The plurality of subframes of each frame are divided into a plurality of divided display periods respectively (Tr11, Tr12, . . . , Tr61, and Tr62), thereby the frequency in the divided display period for each of the subframes is 75 Hz or more.

The frequency in the divided display period for each of the subframes is preferably within a range of 90 Hz to 150 Hz, and more preferably within a range of 100 Hz to 120 Hz. When an inputted digital video signal in frame has a frame frequency of 60 Hz, each of subframes is divided into two divided display periods so that the frequency in the divided display period for each subframes can be 120 Hz.

The pixel matrix portion of the display device preferably comprises an organic EL.

According to the invention, a driving method of the display device (100) in which one frame period of a digital video signal is divided into a plurality of subframe periods (Tr1 to Tr6) each raised to a different power is provided. The driving method comprises a step of converting the frame frequency of an inputted digital video signal in frame, a step of generating a time division gray scale signal in subframe from the digital video signal having the converted frame frequency, and a step of supplying the time division gray scale signal in subframe to a pixel matrix portion of the display device. The frame frequency is converted into a frame frequency of 75 Hz or more in the step of converting the frame frequency.

In the step of converting the frame frequency, the frame frequency is more preferably converted into a frame frequency within a range of 90 Hz to 150 Hz, and still more preferably 100 Hz to 120 Hz.

According to the invention, a driving method of a display device in which one frame period of a digital video signal is divided into a plurality of subframes (Tr1 to Tr6) each raised to a different power is provided. The driving method comprises a step of generating a time division gray scale signal in subframe from an inputted digital video signal in frame, and a step of supplying the time division gray scale signal in subframe to a pixel matrix portion of the display device. A plurality of subframes of each frame are divided into a plurality of divided display periods respectively (Tr11, Tr12, . . . , Tr61, and Tr62) in the step of supplying the time division gray scale signal in subframe to the pixel matrix portion, thereby the frequency in the divided display period for each of the subframes is 75 Hz or more.

The frequency in the divided display period for each of the subframes is preferably within a range of 90 Hz to 150 Hz, and more preferably 100 Hz to 120 Hz. When an inputted digital video signal in frame has a frame frequency of 60 Hz, each of the subframes is divided into two divided display periods so that the frequency in the divided display period for each of the subframes can be 120 Hz.

The pixel matrix portion of the display device preferably comprises an organic EL.

As described above, the frame frequency in a display device is 75 Hz or more so that generation of a pseudo contour can be effectively suppressed in the case of a low gray scale display. When the frame frequency is within a range of 90 Hz to 150 Hz, a pseudo contour can also be suppressed in the case of a higher gray scale display, and the manufacturing cost can be reduced since the frame frequency is not too high. When the frame frequency is within a range of 100 Hz to 120 Hz, a pseudo contour can be effectively suppressed in all cases from a low gray scale display to a high gray scale display.

Further, in a display device, subframes of each frame are divided into a plurality of divided display periods respectively. When the frequency in the divided display period for each of the subframes is 75 Hz or more, generation of a pseudo contour can be effectively suppressed in the case of a low gray scale display. When the frequency in the divided display period for each of the subframes is within a range of 90 Hz to 150 Hz, a pseudo contour can also be suppressed in the case of a higher gray scale display, and the manufacturing cost can be reduced since the frame frequency is not too high. When the frequency in the divided display period for each of the subframes is within a range of 100 Hz to 120 Hz, a pseudo contour can be effectively suppressed in all cases from a low gray scale display to a high gray scale display. In the case where the frame frequency of an inputted digital video signal in frame is 60 Hz, each of subframes is divided into two divided display periods, thereby the frequency in the divided display period for each of the subframes can be 120 Hz with ease.

When the pixel matrix portion of the display device comprises an organic EL, the frame frequency or the frequency in the divided display period as described above can be easily realized since an organic EL responds faster as compared with a liquid crystal and the like.

### BRIEF DESCRIPTION OF THE DRAWINGS

FIG. 1 is a block diagram of a display device which was used for examining a relationship between the frame frequency and a pseudo contour between two pixel regions having different emission timing.

FIG. 2 is a pattern diagram showing image patterns which were used for examining a relationship between the frame frequency and a pseudo contour at a boundary between two pixel regions having different emission timing.

FIG. 3 is timing charts showing display timing of a plurality of image patterns which were used for examining a relationship between the frame frequency and a pseudo contour at a boundary between two pixel regions having different emission timing.

FIG. 4 is a graph showing a relationship between the frame frequency and a pseudo contour at a boundary between two pixel regions having different emission timing, with respect to various duty ratio.

FIG. 5 is a block diagram showing an embodiment of a display device according to the invention.

FIG. 6 is a pattern diagram showing an example of an operation of a frame frequency converter circuit in the display device shown in FIG. 5.

FIG. 7 is a block diagram showing an embodiment of the display device according to the invention.

FIG. 8 is a timing chart showing an example of dividing subframes in the display device shown in FIG. 7.

FIG. 9A to 9H are perspective views showing electronic apparatuses the invention can be applied.

FIG. 10A is a pattern diagram showing a pixel portion of an EL display in which a conventional driving method is used and FIG. 10B is a diagram showing the length ratio between an emission period and a non emission period at a pixel for a 31 gray scale display and a pixel for a 32 gray scale display.

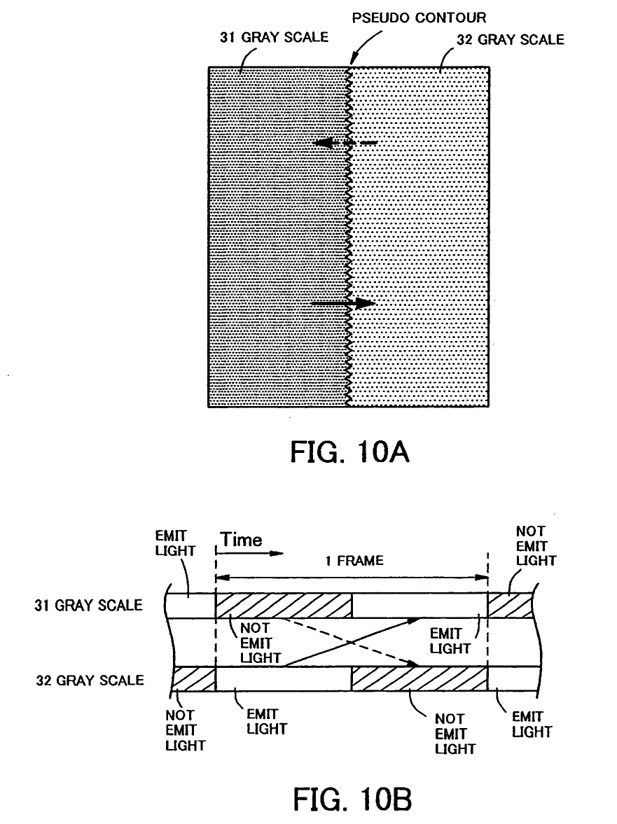

### DETAILED DESCRIPTION OF THE INVENTION

An embodiment mode of the invention is described hereinafter with reference to the drawings.

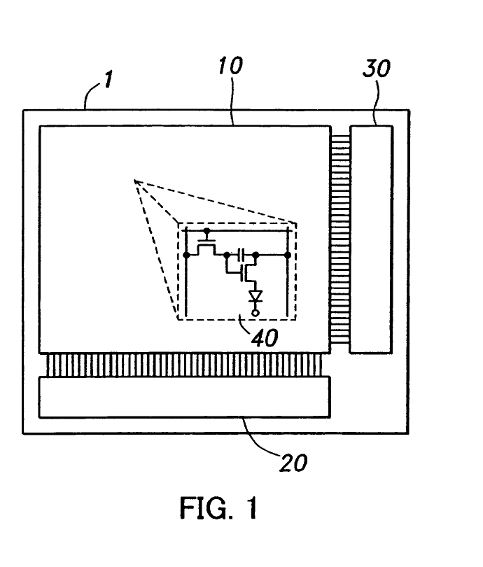

In order to examine a relationship between the frame frequency and a pseudo contour at a boundary between two pixel regions having different emission timing in a time division gray scale display device, a display device 1 shown in FIG. 1 was prepared. The display device 1 comprises a pixel matrix portion 10, a signal line driver circuit 20, and a scan line driver circuit 30. An organic EL is employed as a light-emitting medium of the pixel matrix portion 10. The pixel matrix portion 10 includes a plurality of pixel cells 40 each having a PMOS transistor preferably. It is to be noted that another transistor such as an NMOS transistor can be used as well as a PMOS transistor.

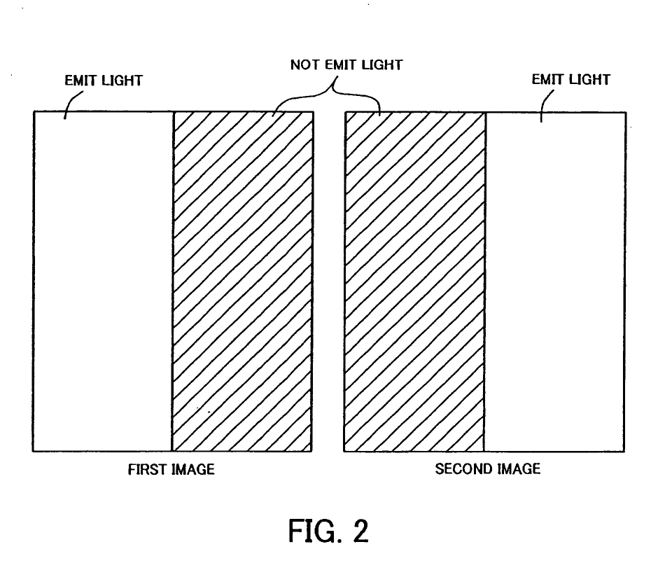

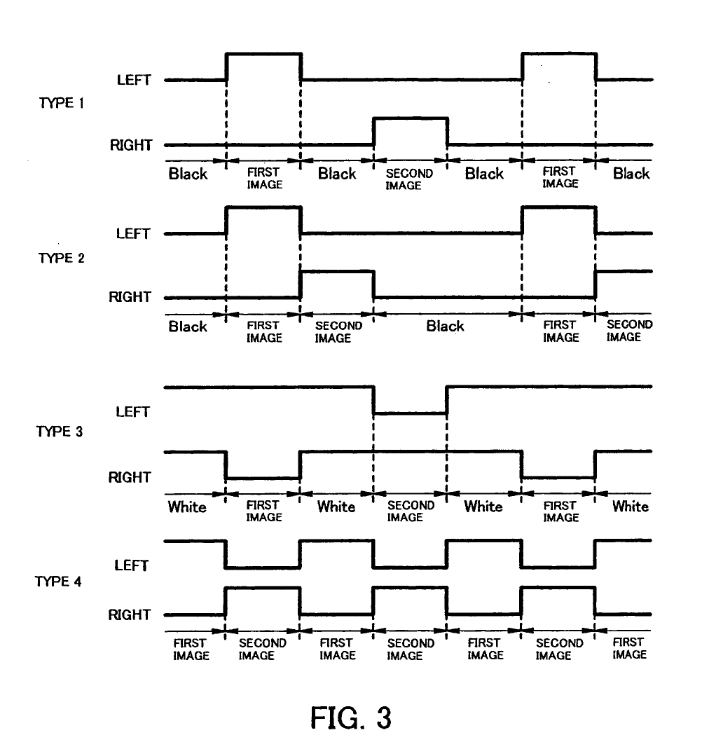

An imitation digital video signal, which was generated by an imitation video signal generation device, was supplied to the display device 1, and as shown in FIG. 2, an image (a first image) where pixels at the left half emit light whereas pixels at the right half do not emit light and an image (a second image) where pixels at the left half do not emit light whereas pixels at the right half emit light were displayed at timing of type 1 to type 4 shown in the timing charts in FIG. 3. The frequency when a pseudo contour was disappeared was measured by gradually increasing the frame frequency (that is, by shortening one cycle) in various gray scales for each of the timing.

In FIG. 3, a reference term “Black” shown in the types 1 and 2 denotes an image where all pixels do not emit light, and a reference term “White” shown in the type 3 denotes an image where all the pixels emit light. In this experiment, the first image and the second image were displayed during the same period in one cycle (or one frame period). Therefore, the perceived gray scale is equal between the right half and the left half on the screen, and no line appears at a boundary in the middle if a pseudo contour is not perceived. In the types 1 to 3, the constant operating voltage was applied to an organic EL, and display periods of Black and White were varied with respect to the display periods of the first image and the second image so that the gray scale of the screen was varied (that is, the gray scale was decreased by increasing the display period of Black whereas the gray scale was increased by increasing the display period of White). The type 1 and the type 2 are different in that Black is displayed between the first image and the second image which are adjacent to each other in the type 1 whereas the second image is displayed just after the first image in the type 2. In the type 4, Black and White were not included, the operating voltage applied to an organic EL was varied and the luminance of an organic EL itself when emitting light was varied so that the gray scale of a display image was varied. It is to be noted here that, where a display period of the first image in one cycle is T1, a display period of the second image is T2, and a period of the one cycle is T, a value obtained by (T1+T2)/T×100 (%) is called a duty ratio.

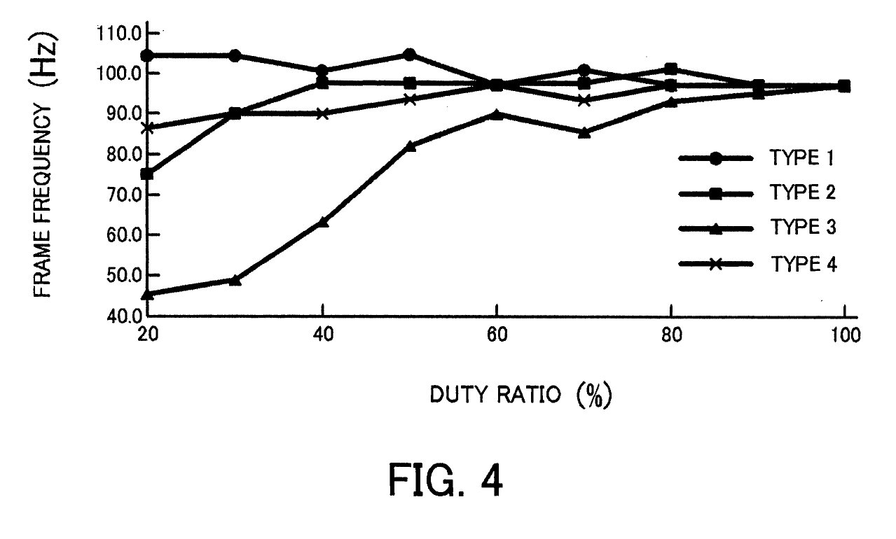

Results of the above experiment are shown in Table 1 and FIG. 4. As for the result in the type 4, a gray scale of the display image obtained by varying the luminance of an organic EL itself is shown while being converted to a duty ratio of a gray scale in the type 1 or 2 corresponding to the gray scale.

TABLE 1

FRAME FREQUENCY (Hz)

| DUTY RATIO | TYPE 1 | TYPE 2 | TYPE 3 | TYPE 4 |
|---|---|---|---|---|
| 20 | 105.0 | 75.0 | 45.0 | 86.3 |
| 30 | 105.0 | 90.0 | 48.8 | 90.0 |
| 40 | 101.3 | 97.5 | 63.8 | 90.0 |
| 50 | 105.0 | 97.5 | 82.5 | 93.8 |
| 60 | 97.5 | 97.5 | 90.0 | 97.5 |
| 70 | 101.3 | 97.5 | 86.3 | 93.8 |
| 80 | 97.5 | 101.3 | 93.8 | 97.5 |
| 90 | 97.5 | 97.5 | | 97.5 |
| 100 | 97.5 | 97.5 | 97.5 | 97.5 |

As shown in the types 1 and 2 in FIG. 4, in the case where the gray scale was varied by interposing Black, a correlation between the duty ratio and the frame frequency when a pseudo contour disappears was weak, and the frame frequency was required to be higher than 60 Hz which is general, in order to suppress a pseudo contour even when the duty ratio was small (that is, in the case of a low gray scale display). That is, a frame frequency of 75 Hz or more was required in the type 2 and a frame frequency of 100 Hz or more was required in the type 1. This means that, further to the conventional knowledge, the frequency in the shortest subframe among a plurality of subframes is also required to be higher than the predetermined value as well as the longest subframe in order to suppress a pseudo contour in a time division gray scale display.

Furthermore, as is clear from FIG. 4, when the frame frequency was about 100 Hz or more, a pseudo contour was not perceived conspicuously at any duty ratio in any type.

As described above, the experimental results show that the preferable frame frequency is about 75 Hz or more. In the case where an inputted video signal has a frame frequency of 60 Hz, it is converted into a video signal having a frame frequency of 90 Hz, which is 1.5 times as high with relatively ease. Therefore, the more preferable frame frequency is 90 Hz or more, and the most preferable frame frequency is 100 Hz or more.

Note that it is not preferable to unnecessarily increase the frame frequency in order to reduce the manufacturing cost. A frame frequency of 150 Hz (2.5 times as high as the frame frequency of the inputted video signal (60 Hz)) or less is preferable, and a frame frequency of 120 Hz (twice as high as the frame frequency of the inputted video signal (60 Hz)) or less is more preferable.

In addition, the result of the type 3 shows that the frame frequency when a pseudo contour is not perceived becomes low as the gray scale is higher (that is, as a ratio of White is higher). Furthermore, as shown in the result of the type 4, the low frame frequency may generate a pseudo contour even if the luminance is low when a power source (an organic EL) emits light, therefore, the frame frequency which is higher than 60 Hz (e.g., a frequency of 85 Hz or more) is required in order to suppress the pseudo contour.

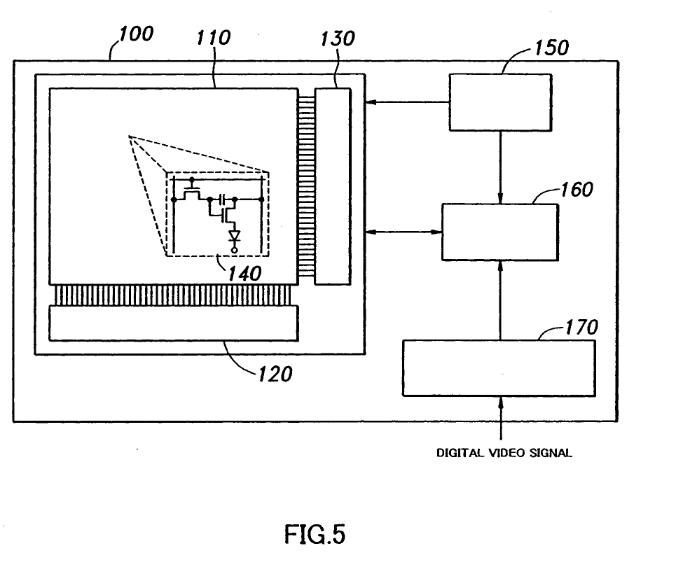

FIG. 5 is a pattern diagram showing an embodiment of a display device of the invention based on the above-described knowledge. The display device 100 comprises the pixel matrix portion 110, the signal line driver circuit 120, the scan line driver circuit 130, the controller 150, the time division gray scale signal generation circuit 160, and the frame frequency converter circuit 170. The pixel matrix portion 110 preferably includes a plurality of pixel cells 40 each having a PMOS transistor. The frame frequency converter circuit 170 is inputted with a video signal in frame. The display device 100 is preferably formed as an organic EL display in which an organic EL is employed as a light-emitting medium of the pixel matrix portion 110, however, a plasma display (PDP) or a liquid crystal display can be formed as well. In addition, an inorganic EL, a LED, or the like may be employed as the light-emitting medium as well.

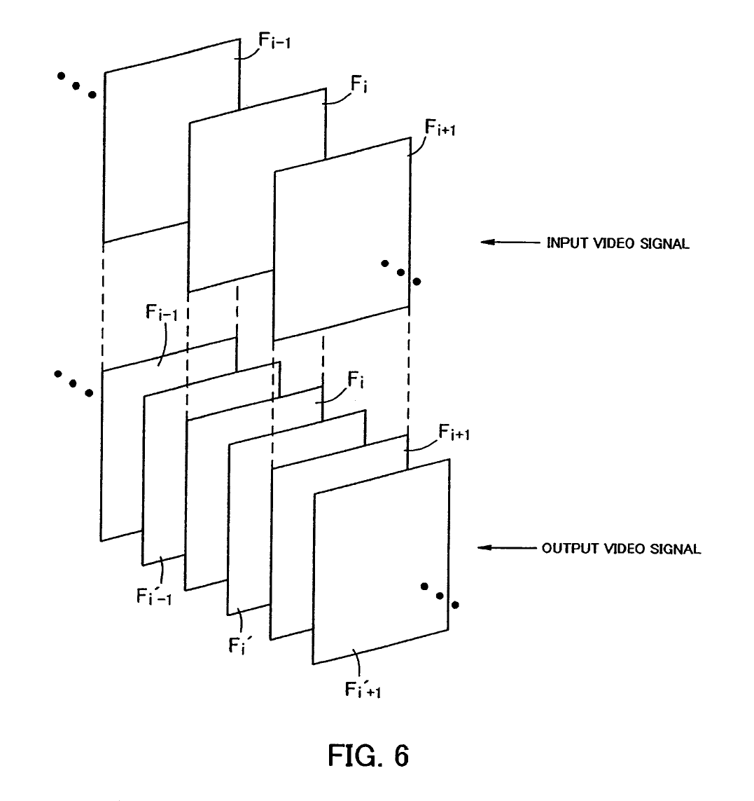

FIG. 6 is a pattern diagram showing an example of an operation of the frame frequency converter circuit 170. As shown in the drawing, an inputted video signal includes a plurality of frames such as Fi−1, Fi, and Fi+1. The frame frequency converter circuit generates an insert frame such as F′i−1, F′i, and F′i+1 based on the inputted video signal, and inserts it after the corresponding original frame. Consequently, the frame frequency can be doubled. The insert frame can, for example, be the same as the corresponding original frame (F′i=Fi). Or, the insert frame may be an average between the corresponding original frame and the subsequent frame (F′i=(Fi+Fi+1)/2). Another method for converting the frame frequency may be employed as well.

The time division gray scale signal generation circuit 160 converts a video signal having the increased frame frequency, which is transmitted from the frame frequency converter circuit 170, into a time division gray scale signal in subframe (that is, a signal for determining whether each pixel emits light or not in each subframe). The time division gray scale signal is transmitted to the pixel matrix portion 110 under control of the controller 150 to drive a pixel.

According to such time division gray scale display device 100, a frame frequency of 100 Hz or more can be realized by the frame frequency converter circuit 170 so that generation of a pseudo contour can be effectively suppressed.

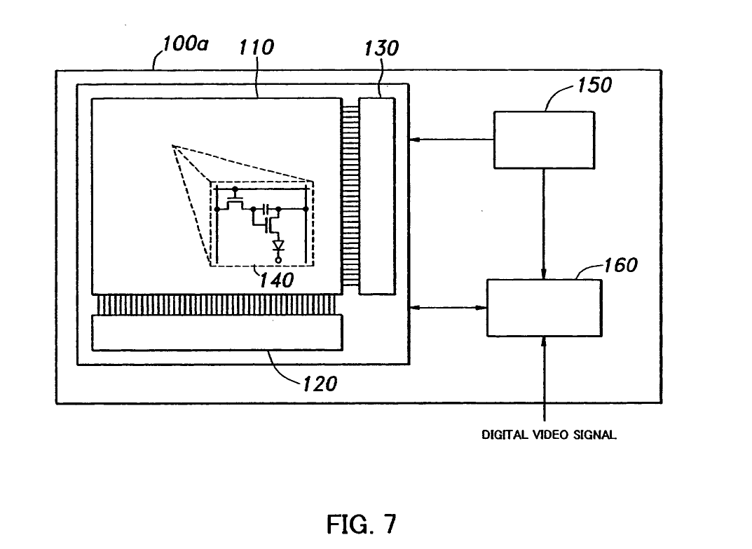

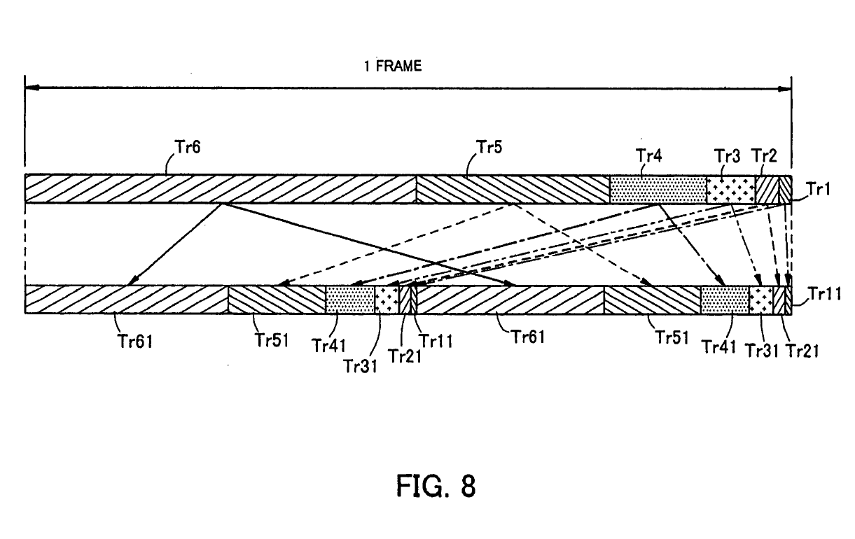

FIG. 7 is a pattern diagram showing an embodiment of a display device of the invention. This display device 100a is different from the display device 100 shown in FIG. 5 in that the frame frequency converter circuit 170 is not provided. An operation method of the controller 150 in this embodiment is described with reference to FIG. 8.

As shown in FIG. 8, the time division gray scale signal generation circuit 160 in this embodiment converts an inputted video signal in frame into digital signals for a plurality of subframes Tr1 to Tr6 (six subframes in the drawing). As shown in the drawing, the controller 150 divides each of the plurality of subframes Tr1 to Tr6 into two divided display periods such as Tr11 and Tr12, . . . , and Tr61 and Tr62, and separately arranges them within one frame period such that respective two divided display periods for each subframe are not adjacent to each other. The arrangement is not limited to the one shown in FIG. 8 so long as respective two divided display periods for each subframe are not adjacent to each other. In addition, the number of the subframes is not limited to six. Accordingly, the frequency in the divided display period (e.g., Tr11 or Tr12) for each subframe (e.g., Tr1) becomes twice as high as the frame frequency (generally 60 Hz), which results in the same effect as the case where the frame frequency is practically increased twice, so that generation of a pseudo contour can be effectively suppressed. In particular, by dividing the shortest subframe Tr1, generation of a pseudo contour can be suppressed in the case of a low gray scale display. It is to be noted that the frame frequency converter circuit is not required in this embodiment, and circuit simplification can be realized.

It is to be noted that each of the subframes Tr1 to Tr6 may be divided into divided display periods of more than two. However, as shown in the above-described experimential results, a frame frequency of about 100 Hz or more is enough to suppress a pseudo contour so that each subframe is preferably divided into two divided display periods (that is, the frequency in a divided display period is 120 Hz) in order to avoid unnecessary division and reduce the manufacturing cost.

As set forth above, a time division gray scale display device and a driving method thereof according to the invention are advantageous in that a pseudo contour is effectively suppressed in a time division gray scale display device.

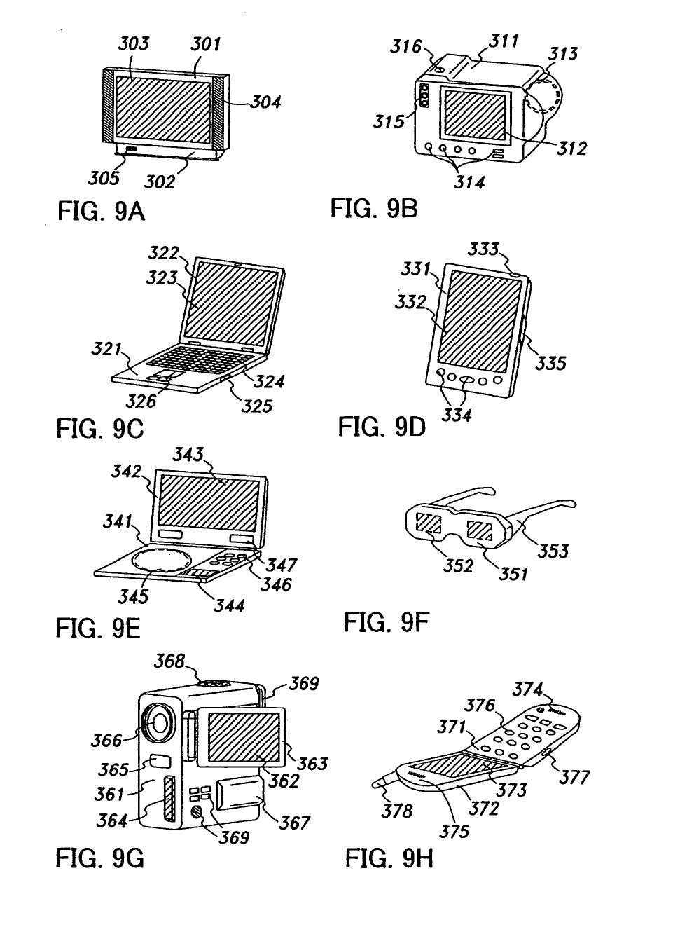

Electronic apparatuses to which the invention can be applied include a desktop, floor stand, or wall-hung display, a video camera, a digital camera, a goggle-type display (head mounted display), a navigation system, a sound reproduction apparatus (e.g., a car audio apparatus and an audio set), a computer, a game machine, a portable information terminal (e.g., a mobile computer, a mobile telephone, a portable game machine, and an electronic book), an image reproduction apparatus comprising a recording medium (specifically, an apparatus which can reproduce an image or a still image stored in a recording medium such as a digital versatile disc (DVD), and comprises a display for displaying it), or the like. Specific examples thereof are shown in FIGS. 9A to 9H.

FIG. 9A shows a desktop, floor stand, or wall-hung display which includes a housing 301, a support base 302, a display portion 303, a speaker portion 304, and a video input terminal 305. The display device of the invention can be applied to the display portion 303. Such a display can be used as any display device for displaying information, such as for a personal computer, a receiver of TV broadcasting, and an advertising display. Accordingly, a display capable of performing a clear display without a pseudo contour can be realized.

FIG. 9B shows a digital camera which includes a main body 311, a display portion 312, an image receiving portion 313, operating keys 314, an external connection port 315, and a shutter 316. The display device of the invention can be applied to the display portion 312. Accordingly, a digital camera capable of performing a clear display without a pseudo contour can be realized.

FIG. 9C shows a computer which includes a main body 321, a housing 322, a display portion 323, a keyboard 324, an external connection port 325, and a pointing mouse 326. The display device of the invention can be applied to the display portion 323. Accordingly, a computer capable of performing a clear display without a pseudo contour can be realized. It is to be noted that the computer includes a laptop computer in which a central processing unit (CPU), a recording medium, and the like are integrally mounted and a so-called desktop computer in which they are provided separately.

FIG. 9D shows a mobile computer which includes a main body 331, a display portion 332, a switch 333, operating keys 334, and an infrared port 335. The display device of the invention can be applied to the display portion 332. Accordingly, a mobile computer capable of performing a clear display without a pseudo contour can be realized.

FIG. 9E shows a portable image reproduction apparatus comprising a recording medium (specifically, a DVD reproduction apparatus), which includes a main body 341, a housing 342, a first display portion 343, a second display portion 344, a recording medium (e.g., DVD) reading portion 345, an operating key 346, and a speaker portion 347. The first display portion 343 is used mainly for displaying image information, while the second display portion 344 is used mainly for displaying character information. The display device of the invention can be applied to the first and second display portions 343 and 344. Accordingly, an image reproduction apparatus capable of performing a clear display without a pseudo contour can be realized. The image reproduction apparatus comprising a recording medium further includes a home game machine or the like.

FIG. 9F shows a goggle-type display (head mounted display) which includes a main body 351, a display portion 352, and an arm portion 353. The display device of the invention can be applied to the display portion 352. Accordingly, a goggle-type display capable of performing a clear display without a pseudo contour can be realized.

FIG. 9G shows a video camera which includes a main body 361, a display portion 362, a housing 363, an external connection port 364, a remote control receiving portion 365, an image receiving portion 366, a battery 367, a sound input portion 368, and an operating key 369. The display device of the invention can be applied to the display portion 362. Accordingly, a video camera capable of performing a clear display without a pseudo contour can be realized.

FIG. 9H shows a mobile telephone which includes a main body 371, a housing 372, a display portion 373, a sound input portion 374, a sound output portion 375, an operating key 376, an external connection port 377, and an antenna 378. The display device of the invention can be applied to the display portion 373. Accordingly, a mobile telephone capable of performing a clear display without a pseudo contour can be realized.

Display portions of the electronic apparatuses as described above may be formed as a self light-emitting type in which a light-emitting element such as a LED and an organic EL is used in each pixel, or may be formed in which a light source such as a backlight is used like a liquid crystal display. In the case of a self light-emitting type, no backlight is required and a display portion can be thinner than a liquid crystal display.

In addition, the above-described electronic apparatuses have displayed information distributed through an electronic communication line such as the Internet and a CATV (cable television) or have been used as TV receptors increasingly. In particular, an opportunity for displaying moving image information is increasing. A display device of a self light-emitting type is suitable for such a moving image display since a light-emitting material such as an organic EL responses much faster as compared with a liquid crystal. Furthermore, it is also suitable for performing time division driving. When the luminance of a light-emitting material is increased in the future, outputted light containing image information can be magnified and projected by a lens and the like for a front projector or a rear projector.

In a self light-emitting display portion, it is preferable to display information so as to reduce a light-emitting part which consumes power as much as possible. Therefore, in the case where a display portion of a portable information terminal, in particular, of a mobile telephone, a sound reproduction apparatus or the like which mainly displays character information is of a self light-emitting type, it is preferable to drive so as to form the character information by means of a light-emitting part with a non light-emitting part as a background.

As described above, application range of the invention is quite wide, and the invention can be employed in electronic apparatuses of various fields.

This application is based on Japanese Patent Application serial no. 2004-092516 filed in Japan Patent Office on 26, Mar. 2004, the entire contents of which are hereby incorporated by reference.

1. A display device wherein one frame period of a digital video signal comprises a plurality of subframes each having a different period, comprising:
a pixel matrix portion;
a signal line driver circuit;
a scan line driver circuit;
a frame frequency converter circuit for converting a frame frequency of an inputted digital video signal in frame;
a time division gray scale signal generation circuit for converting a digital video signal in frame from the frame frequency converter circuit into a time division gray scale signal in subframe; and
a controller for supplying the time division gray scale signal to the pixel matrix portion by controlling the time division gray scale signal generation circuit, the scan line driver circuit, and the signal line driver circuit,
wherein the frame frequency converter circuit outputs a digital video signal having a frame frequency of 75 Hz or more.

2. The display device according to claim 1, wherein the frame frequency converter circuit outputs the digital video signal having a frame frequency within a range of 90 Hz to 150 Hz.

3. The display device according to claim 1, wherein the frame frequency converter circuit outputs the digital video signal having a frame frequency within a range of 100 Hz to 120 Hz.

4. A display device wherein one frame period of a digital video signal comprises a plurality of subframes each having a different period, comprising:
a pixel matrix portion;
a signal line driver circuit;
a scan line driver circuit;
a time division gray scale signal generation circuit for converting an inputted digital video signal in frame into a gray scale signal in subframe; and
a controller for supplying the time division gray scale signal to the pixel matrix portion by controlling the time division gray scale signal generation circuit, the scan line driver circuit, and the signal line driver circuit,
wherein the plurality of subframes of each frame are divided into a plurality of divided display periods, thereby a frequency in the divided display period for each of the subframes is 75 Hz or more.

5. The display device according to claim 4, wherein a frequency in the divided display period for each of the subframes is within a range of 90 Hz to 150 Hz.

6. The display device according to claim 4, wherein a frequency in the divided display period for each of the subframes is within a range of 100 Hz to 120 Hz.

7. The display device according to claim 4, wherein a frame frequency of the inputted digital video signal in frame is 60 Hz, each of the subframes is divided into two divided display periods, and a frequency in the divided display period for each of the subframes is 120 Hz.

8. The display device according to claim 1, wherein the pixel matrix portion comprises an organic EL.

9. A driving method of a display device wherein one frame period of a digital video signal comprises a plurality of subframes each having a different period, comprising:
a step of converting a frame frequency of an inputted digital video signal in frame;
a step of generating a time division gray scale signal in subframe from the digital video signal having the converted frame frequency; and
a step of supplying the time division gray scale signal in subframe to a pixel matrix portion of the display device,
wherein the step of converting a frame frequency converts the frame frequency into a frame frequency of 75 Hz or more.

10. The driving method of a display device according to claim 9, wherein the step of converting a frame frequency converts the frame frequency into a frame frequency within a range of 90 Hz to 150 Hz.

11. The driving method of a display device according to claim 9, wherein the step of converting a frame frequency converts the frame frequency into a frame frequency within a range of 100 Hz to 120 Hz.

12. A driving method of a display device wherein one frame period of a digital video signal comprises a plurality of subframes each having a different period, comprising:
a step of generating a time division gray scale signal in subframe from an inputted digital video signal in frame; and
a step of supplying the time division gray scale signal in subframe to a pixel matrix portion of the display device,
wherein the plurality of subframes of each frame are divided into a plurality of divided display periods respectively in the step of supplying the time division gray scale signal in subframe to the pixel matrix portion, thereby a frequency in the divided display period for each of the subframes is 75 Hz or more.

13. The driving method of a display device according to claim 12, wherein a frequency in the divided display period for each of the subframes is within a range of 90 Hz to 150 Hz.

14. The driving method of a display device according to claim 12, wherein a frequency in the divided display period for each of the subframes is within a range of 100 Hz to 120 Hz.

15. The driving method of a display device according to claim 12, wherein a frame frequency of an inputted digital video signal in frame is 60 Hz, each of the subframes is divided into two divided display periods, and a frequency in the divided display period for each of the subframes is 120 Hz.

16. The driving method of a display device according to claim 9, wherein the pixel matrix portion of the time division gray scale display device comprises an organic EL.

17. An electronic apparatus having a display device in which one frame period of a digital video signal has a plurality of subframes each raised to a different power,
wherein the display device comprises:
a pixel matrix portion;
a signal line driver circuit;
a scan line driver circuit;
a frame frequency converter circuit for converting a frame frequency of an inputted digital video signal in frame;
a time division gray scale signal generation circuit for converting a digital video signal in frame from the frame frequency converter circuit into a gray scale signal in subframe; and
a controller for supplying the time division gray scale signal to the pixel matrix portion by controlling the time division gray scale signal generation circuit, the scan line driver circuit, and the signal line driver circuit, and
wherein the frame frequency converter circuit outputs a digital video signal having a frame frequency of 75 Hz or more.

18. An electronic apparatus having a display device in which one frame period of a digital video signal has a plurality of subframes each raised to a different power,
wherein the display device comprises:
a pixel matrix portion;
a signal line driver circuit;
a scan line driver circuit;
a time division gray scale signal generation circuit for converting a digital video signal in frame into a gray scale signal in subframe; and
a controller for supplying the time division gray scale signal to the pixel matrix portion by controlling the time division gray scale signal generation circuit, the scan line driver circuit, and the signal line driver circuit, and
wherein the plurality of subframes of each frame are divided into a plurality of divided display periods respectively, thereby a frequency in the divided display period for each of the subframes is 75 Hz or more.

19. The electronic apparatus according to claim 17, wherein the electronic apparatus is selected from the group consisting of a desktop display, a floor stand display, a wall- hung display, a digital camera, a computer, a mobile computer, a portable image reproduction apparatus, a goggle-type display, a video camera and a mobile telephone.

20. The electronic apparatus according to claim 18, wherein the electronic apparatus is selected from the group consisting of a desktop display, a floor stand display, a wall- hung display, a digital camera, a computer, a mobile computer, a portable image reproduction apparatus, a goggle-type display, a video camera and a mobile telephone.

21. The display device according to claim 2, wherein the pixel matrix portion comprises an organic EL.

22. The display device according to claim 3, wherein the pixel matrix portion comprises an organic EL.

23. The display device according to claim 4, wherein the pixel matrix portion comprises an organic EL.

24. The display device according to claim 5, wherein the pixel matrix portion comprises an organic EL.

25. The display device according to claim 6, wherein the pixel matrix portion comprises an organic EL.

26. The display device according to claim 7, wherein the pixel matrix portion comprises an organic EL.

27. The driving method of a display device according to claim 10, wherein the pixel matrix portion of the time division gray scale display device comprises an organic EL.

28. The driving method of a display device according to claim 11, wherein the pixel matrix portion of the time division gray scale display device comprises an organic EL.

29. The driving method of a display device according to claim 12, wherein the pixel matrix portion of the time division gray scale display device comprises an organic EL.

30. The driving method of a display device according to claim 13, wherein the pixel matrix portion of the time division gray scale display device comprises an organic EL.

31. The driving method of a display device according to claim 14, wherein the pixel matrix portion of the time division gray scale display device comprises an organic EL.

32. The driving method of a display device according to claim 15, wherein the pixel matrix portion of the time division gray scale display device comprises an organic EL.
